(19) United States
(12) Patent Application Publication
(10) Pub. No.: US 2011/0280742 A1
(43) Pub. Date: Nov. 17, 2011

(54) BALANCE DRUM CONFIGURATION FOR COMPRESSOR ROTORS

(76) Inventor: Denis Guillaume Jean GUENARD, Firenze (IT)

(21) Appl. No.: 13/104,482

(22) Filed: May 10, 2011

(30) Foreign Application Priority Data
May 11, 2010 (IT) CO2010A000025

(51) Int. Cl. F04B 5/00; F01D 25/04; B23P 15/00

(52) U.S. Cl. 417/245; 29/888.02; 415/119

(57) ABSTRACT

Method and system for a rotary machine, e.g., a back-to-back compressor. A first section includes a first inlet duct, at least one first impeller and a first outlet duct. A second section includes a second inlet duct, at least one second impeller and a second outlet duct. The first section and second section share a common rotor. A first balance drum is disposed between the two sections, while a second section is disposed between the first inlet duct and the rotor. In a single section compressor, the balance drum can be disposed on the inlet side of an impeller rather than a discharge side.

### BACKGROUND

1. Technical Field

Embodiments of the subject matter disclosed herein generally relate to methods and systems and, more particularly, to mechanisms and techniques for balancing a compressor rotor.

2. Discussion of the Background

A compressor is a machine which increases the pressure of a compressible fluid, e.g., a gas, through the use of mechanical energy. Compressors are used in a number of different applications, including operating as an initial stage of a gas turbine engine. Gas turbine engines, in turn, are themselves used in a large number of industrial processes, including power generation, natural gas liquification and other processes. Among the various types of compressors used in such processes and process plants are the so-called centrifugal compressors, in which the mechanical energy operates on gas input to the compressor by way of centrifugal acceleration which accelerates the gas particles, e.g., by rotating a centrifugal impeller or rotor through which the gas passes.

Centrifugal compressors can be fitted with a single impeller or stage, i.e., a single stage configuration, or with a plurality of stages in series, in which case they are frequently referred to as multistage compressors. In turn, a specific sub-family of multi-stage compressor includes a multi-section multistage compressor which is configured such that the totality of the compressor flow is extracted from the compressor, cooled down and then re-injected into the compressor. Most of the time, the number of sections in this sub-family of multistage compressor is limited to two which sections can be arranged in either an in-line or a back-to-back configuration depending on a relative orientation of the impellers of a second section with respect to the impellers in a first section.

Each of the stages of a centrifugal compressor typically includes an inlet conduit for gas to be compressed, an impeller or wheel which is capable of providing kinetic energy to the input gas and an exit system, referred to as a stator, which converts the kinetic energy of the gas leaving the rotor into pressure energy. Multiple stator component configurations can be used, the most common ones being the vaneless diffuser, the vaned diffuser return channel, discharge scroll or plenum or combinations of these configurations. The combination of an individual impeller and its associated stator component is typically referred to as a stage.

Multistage centrifugal compressors are subjected to an axial thrust on the rotor caused by the differential pressure across the stages and the change of momentum of the gas turning from the horizontal to the vertical direction. This axial thrust is normally compensated by a balance piston and an axial thrust bearing. Since the axial thrust bearing cannot be loaded by the entire thrust of the rotor, a balance piston is designed to compensate for most of the thrust, leaving the bearing to handle any remaining, residual thrust. The balance piston is normally implemented as a rotating disc or drum which is fitted onto the compressor shaft, such that each side of the balance disc or drum is subjected to different pressures during operation. The diameter of the balance piston is chosen to have a desired axial load to avoid its residual load from overloading the axial bearing. Conventional oil-lubricated bearings are typically designed to withstand axial thrust forces on the order of four times the maximum residual axial thrust which are expected to occur during abnormal, e.g., surging, conditions.

However, when the gas conditions change during operation of the compressor, or when the compressor is inoperative but pressurized, the compensation provided by a single balance piston may not be sufficient to avoid bearing overload. All multistage compressors are normally fitted with as many balance drums as there are compression sections to be able to be balanced under transient cases (sometimes called “transient settle out pressure”) during which pressure is constant/uniform on one section of the compressor but can differ from one section to another.

Thus in, for example, back-to-back centrifugal compressors, a second balance piston is typically provided between the back-to-back sections of the compressor for additional compensation of axial thrust along the rotor which is shared by the two compressor sections. However the provision of a second balance piston has the drawback that it adds to the axial length of the compressor as a whole, which is detrimental as greater axial length of the compressor as a whole may make the device less safe and/or reduce the number of compressor stages which can be aggregated into a single device.

Accordingly, it would be desirable to design and provide methods and systems for dynamic thrust balancing in such compressors which overcome the aforementioned drawbacks of existing balancing systems.

### SUMMARY

According to an exemplary embodiment, a back-to-back compressor includes a housing, a rotor, a first compressor section having a first inlet duct configured to conduct process gas into the first compressor section, a first outlet duct configured to conduct pressurized process gas out of the first compressor section, at least one first impeller connected to the rotor between the first inlet duct and the first outlet duct, and a first balance drum connected to the rotor and disposed, at least in part, between the first inlet duct and the rotor, and a second compressor section having a second inlet duct configured to conduct process gas into the second compressor section, a second outlet duct configured to conduct pressurized process gas out of the second compressor section, at least one second impeller connected to the rotor between the second inlet duct and the second outlet duct, and a second balance drum connected to the rotor and disposed between the first compressor section and the second compressor section, wherein a first volume of said first inlet duct is greater than a second volume of said second inlet duct.

According to another exemplary embodiment, a method of manufacturing a back-to-back compressor include the steps of fabricating a first compressor section having a first inlet duct configured to conduct process gas into the first compressor section, a first outlet duct configured to conduct pressurized process gas out of the first compressor section, connecting at least one first impeller to a rotor between the first inlet duct and the first outlet duct, and connecting a first balance drum to the rotor disposed, at least in part, between the first inlet duct and the rotor, fabricating a second compressor section having a second inlet duct configured to conduct process gas into the second compressor section, a second outlet duct configured to conduct pressurized process gas out of the second compressor section wherein a first volume of said first inlet duct is greater than a second volume of said second inlet duct, and connecting at least one second impeller connected to the rotor between the second inlet duct and the second outlet duct, and connecting a second balance drum to the rotor between the first compressor section and the second compressor section.

According to still another exemplary embodiment, a rotary machine includes a housing configured to contain elements of the rotary machine, a rotor configured to rotate at least some of the elements of the rotary machine, an inlet duct configured to conduct process gas into the rotary machine, an outlet duct configured to conduct pressurized process gas out of the first section, at least one impeller connected to the rotor between the inlet duct and the outlet duct and configured to pressurize the process gas, and a balance drum connected to the rotor, disposed, at least in part, between the inlet duct and the rotor, and configured to balance axial thrust.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a compressor;

FIG. 2 depicts axial thrust associated with a compressor;

FIG. 3 is a partial cutaway view of a conventional back-to-back compressor;

FIG. 4 is a partial cutaway view of a back-to-back compressor with a relocated balance drum according to an exemplary embodiment;

FIG. 5 illustrates relocation of the balance drum and adaptation of a first inlet duct under which the balance drum is disposed according to an exemplary embodiment;

FIG. 6 shows a bolted rotor configuration which can be used according to an exemplary embodiment;

FIG. 7 depicts a relocated balance drum in a compressor using a bolted rotor configuration according to an exemplary embodiment;

FIG. 8 is a flowchart illustrating a method for manufacturing a compressor according to an exemplary embodiment;

FIG. 9(a) depicts a stage of a conventional inline compressor; and

FIG. 9(b) depicts a stage of an inline compressor according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a multistage centrifugal compressor. However, the embodiments to be discussed next are not limited to this compressor, but may be applied to other type of compressors, turbines, pumps, etc.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

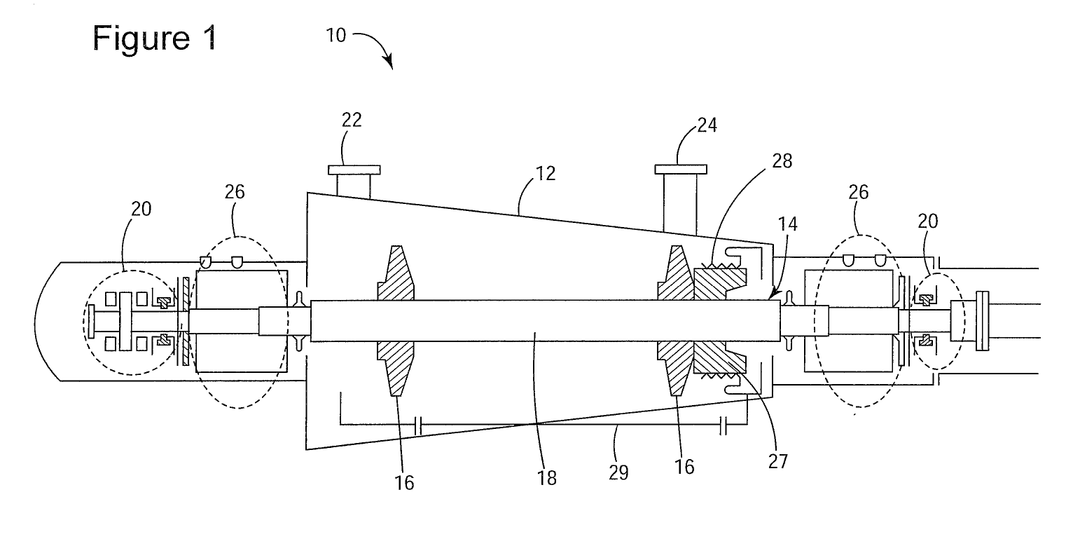

To provide some context for the subsequent discussion relating to thrust balancing systems according to these exemplary embodiments, FIG. 1 schematically illustrates a multistage, centrifugal compressor 10. Therein, the compressor 10 includes a box or housing (stator) 12 within which is mounted a rotating compressor shaft 14 that is provided with a plurality of centrifugal impellers 16. The rotor assembly 18 includes the shaft 14 and impellers 16 and is supported radially and axially through bearings 20 which are disposed on either side of the rotor assembly 18.

The multistage centrifugal compressor operates to take an input process gas from inlet duct 22, to increase the process gas' pressure through operation of the rotor assembly 18, and to subsequently expel the process gas through outlet duct 24 at an output pressure which is higher than its input pressure. The process gas may, for example, be any one of carbon dioxide, hydrogen sulfide, butane, methane, ethane, propane, liquefied natural gas, or a combination thereof. Between the rotors 16 and the bearings 20, sealing systems 26 are provided to prevent the process gas from flowing to the bearings 20. The housing 12 is configured to cover both the bearings 20 and the sealing systems 26, to prevent the escape of gas from the centrifugal compressor 10. The bearings 20 may be implemented as either oil-lubricated bearings or active magnetic bearings. If active magnetic bearings are used as bearings 20, then the sealing mechanisms 26 may be omitted.

The centrifugal compressor 10 also includes the afore-described balance piston (drum) 28 along with its corresponding labyrinth seal 30. A balance line 32 maintains the pressure in a balance chamber 34 on the outboard side of the balance drum at the same (or substantially the same) pressure as that of the process gas entering via the inlet duct 22.

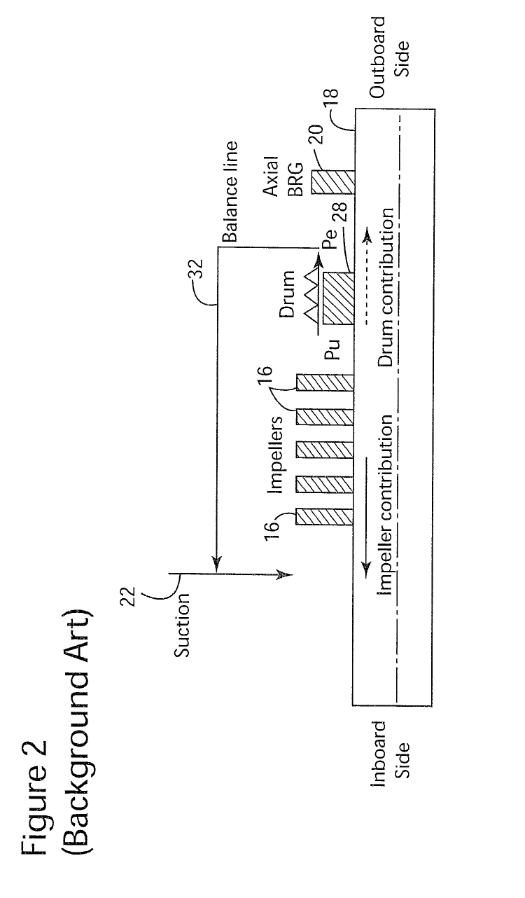

It will also be useful to describe the interaction of the various elements shown in FIG. 1 as they relate to axial loading in general in centrifugal compressor by discussing FIG. 2. Therein, the various axial loading forces associated with operation of the centrifugal compressor 10 are illustrated conceptually. As shown in FIG. 2, the impellers 16 place an axial load (force) on the bearings 20 in the direction of the inboard (low pressure) side of the compressor 10 due to, e.g., differences between stages, changes in gas momentum, etc.. Although not shown in FIG. 2, the motor which rotates the compressor shaft 18 will place a (substantially constant) axial load in the opposite direction, i.e., toward the outboard (high pressure) side of the centrifugal compressor 10. To counteract the remaining axial load of the impellers 16, the balancing drum 28 is designed to exert an axial force in the outboard direction, the magnitude of which is based on the expected axial load of the impellers minus that of the motor. This is accomplished by, for example, designing the system such that the pressure Pu of the process gas on the inboard side of the balancing drum 28 is greater than the pressure Pe on the outboard side of the balancing drum 28, and by selecting a balancing drum of an appropriate size (diameter) to generate the desired balancing force. The pressure imbalance is developed and maintained by providing the balance line 32 between the balance chamber 34 and the main suction line associated with inlet duct 22 such that the pressure in the balance chamber is substantially the same as that on the inboard side of the impellers 16.

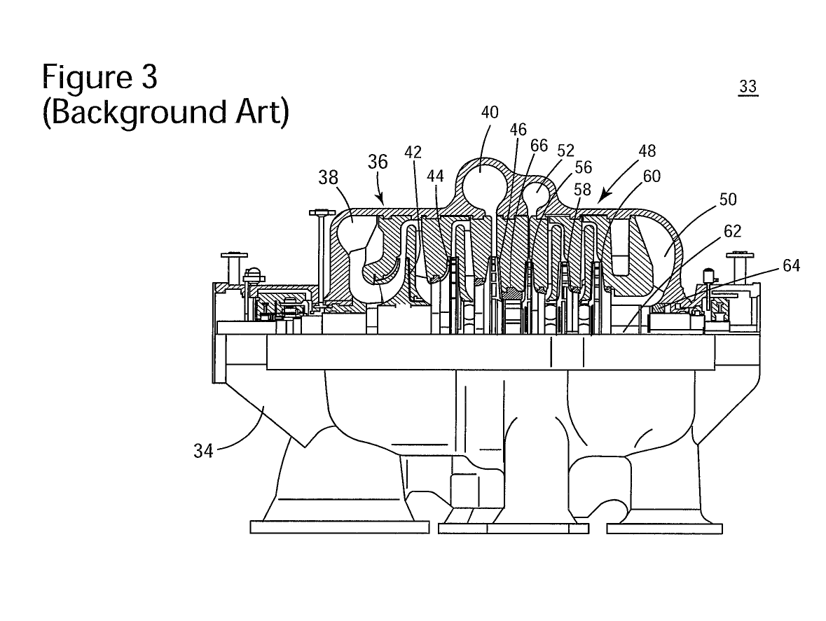

The configuration illustrated and discussed above involves a so-called “straight-through” compressor configuration, wherein the process or working gas enters via the inlet duct 22 on one end of the housing 12 and exits via the outlet duct 24 at another end of the housing 12. However, as mentioned in the Background section, another compressor configuration which is sometimes employed is the so-called “back-to-back” compressor configuration wherein two substantially independent compressors share a single rotor 18, an example of which is illustrated in FIG. 3. Therein, the upper half of the housing 34 is cut-away to reveal the inner workings of the back-to-back compressor 33 including a first compressor section 36 having an inlet duct 38 and an outlet duct 40 near the middle of the compressor. Between the inlet duct 38 and the outlet duct 40 in the first section are three impeller stages 42, 44 and 46 which operate as described above to pressurize the working gas. Similarly, the second compressor section 48 has an inlet duct 50 and an outlet duct 52, the latter of which is also proximate the middle of the compressor 33, and has three impeller stages 54, 46, and 58 associated therewith. Typically, the inlet duct 50 is connected to outlet duct 40 of the first section 36 after the flow has been cooled and the compression process of the gas then continues up to the second section's outlet duct 52.

Unlike the straight-through, single section compressor 10, the back-to-back compressor 33 has two balancing pistons or drums with the same (or substantially the same) diameter to provide for a balanced rotor 62. This is due, at least in part, to the fact that the two compressor sections 36 and 48 will have different pressures associated with them, especially when the compressor 33 is in a stopped or stand-by mode. A first balancing piston or drum 64 is disposed under the inlet duct 50 of the second compressor section, while a second balancing piston or drum 66 is placed in the middle of the compressor 33 between the first compressor section 36 and the second compressor section 48. In operation, balance drum 64 will experience, on one of its faces, the suction pressure of the second section 48 while the other face of the balance drum 64 will experience the suction pressure of the first section 36 due to connection of this face to the first section inlet 38 by mean of an external pipe called a balanced line. Both the first and second balancing drums 64, 66 rotate with the rotor 62. As mentioned in the Background section, this addition of a second balancing piston or drum in the back-to-back configuration adds to the axial length of the compressor 33, which is generally undesirable.

The first balancing piston 64 also contributes to an increase in axial length of the compressor 33. For example, if one designates the axial length of the span associated with a distance between impellers 58 and 60 to be L1, a typical distance L2 between the impeller 60 and the first balancing piston 64 is typically on the order of 1.5 to 2 times L1. Thus it would be desirable to consider a new configuration in which the amount of axial length associated with the balancing piston or drums 64 and 66 is reduced.

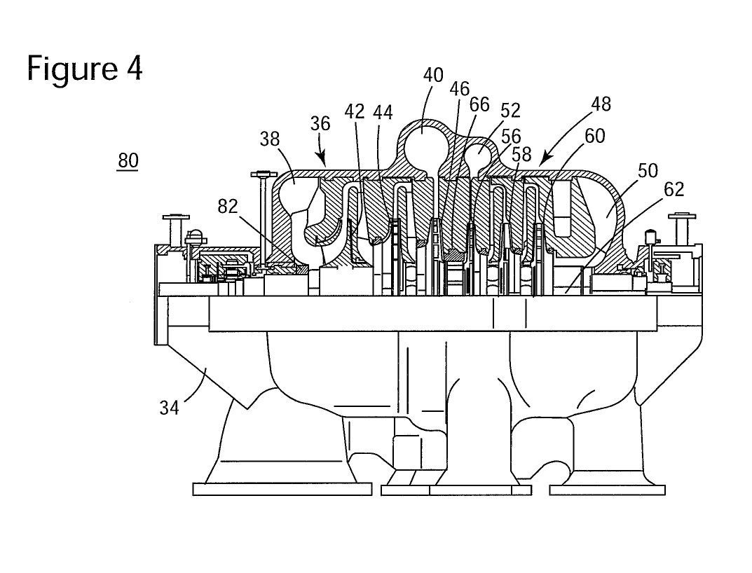

According to an exemplary embodiment, this can be accomplished by, for example, moving the first balancing piston or drum 64 from its typical position proximate the second inlet duct 50, as shown in FIG. 3, to a new position proximate the first inlet duct 38, as shown in FIG. 4. In FIG. 4, a back-to-back compressor 80 in accordance with an exemplary embodiment is illustrated, wherein the same reference numerals are used to describe the same or similar elements as described above with respect to FIG. 3. However it will be seen that the first balance drum 82 is now present below the first inlet duct 38 (and is removed from below the second inlet duct 50), such that the first balance drum 82 is now disposed between the first inlet duct 38 and the rotor 62. The first inlet duct 38 can be distinguished from the second inlet duct 50 in that the first inlet duct 38 has a greater volume than the second inlet duct 50. Additionally, the motor (not shown) which rotates the rotor 62 is typically positioned on the side of the second section 48 of the rotary machine 80. The second balance drum 66 is still disposed between the first and second compressor sections.

This re-positioning of the second balance drum reduces the overall axial length of the rotor 62. For example, by moving the second balance drum from the position shown in FIG. 3, to the position shown in FIG. 4, it is estimated that about ⅔ of the axial length of the second balance drum can be saved. As a purely illustrative example, this amounts to about 40 mm (for a balance drum which takes 60 mm of axial length) on a rotor 62 having an axial length of 1515 mm, which improves the safety of the compressor and either reduces the overall axial size of the compressor or enables other elements to use the axial space.

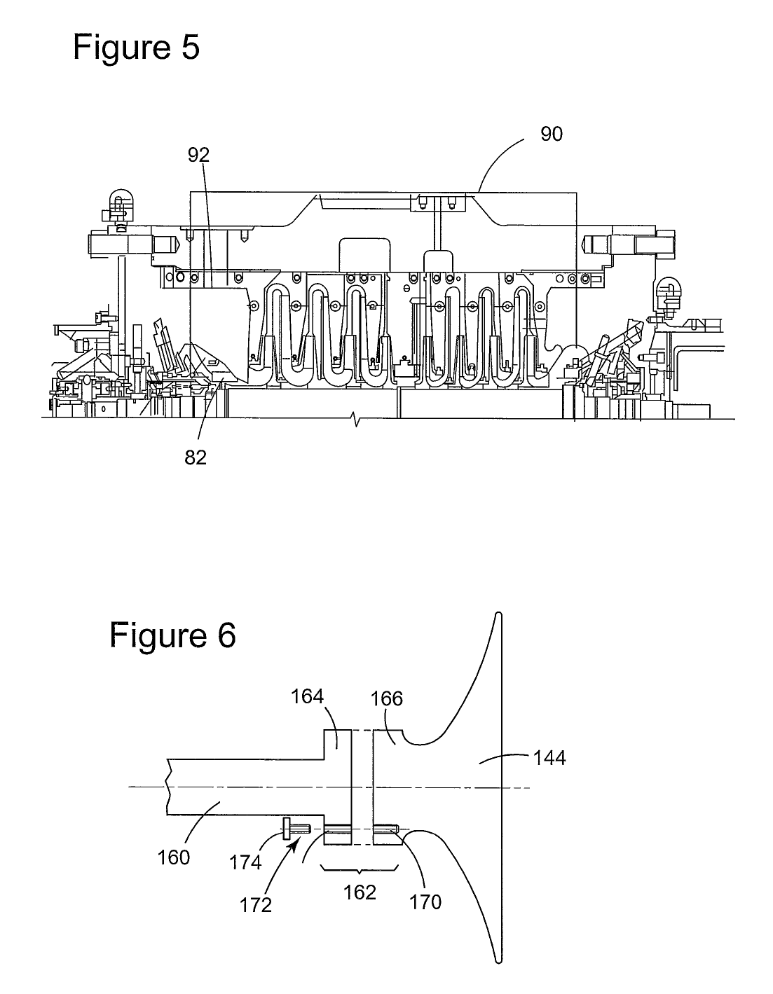

As seen in FIG. 5, another difference between the exemplary embodiment of FIG. 4, and the balance drum configuration of FIG. 3, is that the outward side of the balance drum 82 will be connected to the suction (pressure) of the second inlet duct 50 via balance line 90, whereas the outward side of balance drum 64 is connected to the suction (pressure) of the first inlet duct 38. This means that, in accordance with exemplary embodiments, both of the dry gas seals 26 disposed on opposite ends of the rotor 62 will operate at the suction pressure of the second inlet duct 50, rather than at the suction pressure of the first inlet duct 38 as in the conventional arrangement. Since the dry gas seals operate at the higher pressure of the second inlet duct 50, this feature may be advantageous, for example, in compressors which have a first compressor section operating at atmospheric or lower pressures (i.e., at the first inlet 38) or disadvantageous in the case of compressors which operate at a very high pressure at the suction inlet 50 of the second section 48. Also shown in FIG. 5 is the removal of the first balance drum from the space proximate the second inlet duct, as denoted by the “X” in the Figure and the corresponding reduction in axial space utilization, as denoted by the arrow in the Figure and it can further be seen that the inlet duct 92 of the first section of the compressor is shaped or configured to permit the balance drum 82 to be placed on this side of the compressor.

As shown above with respect to the exemplary embodiments of FIGS. 4 and 5, some back-to-back centrifugal compressors employ unitary, i.e., one piece, rotors. However, according to another exemplary embodiment, a rotor of a machine like a compressor can include multiple parts, an example of which is shown in FIG. 6. Therein, a solid first rotor part 160 is configured to be attached to the first impeller 144. An interface 162 between the solid first rotor part 160 and the first impeller 144 may include various elements for achieving the connection between the solid first rotor part 160 and the impeller 144. For example, as shown in FIG. 6, interface 162 may include a flange 164 that is attached to the solid first rotor part 160 and a flange 166 that is attached to the first impeller 144. Flanges 164 and 166 are configured to be attached to each other. According to an exemplary embodiment, flanges 164 and 166 have one or more holes 168 and 170 in which one or more bolts 172 are provided. Bolt 172 may have a threaded region that threads into a corresponding threaded region inside hole 170 of flange 166. An end 174 of bolt 172 may completely be accommodated by hole 168, by having, for example, a first part of hole 168 drilled with a larger diameter. Alternately, the end 174 of bolt 172 may stay outside flange 164.

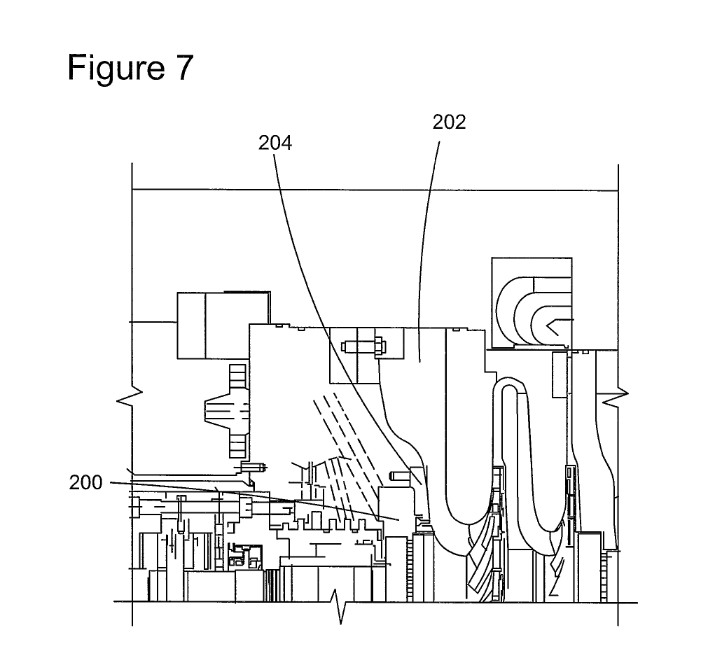

When employing this so-called stacked rotor with a bolted flange configuration, one of the balance drums 200 can also be mounted proximate the first inlet duct 202 in the manner described with respect to FIGS. 4 and 5, and as shown in FIG. 7. Therein, it can be seen that a connecting flange 204 is disposed between the balance drum 200 and the first inlet duct 202. According to exemplary embodiments, one of the flanges 164, 166, 202 can be configured (e.g., dimensioned in terms of diameter to be the same as or substantially the same as the diameter of the balance drum 66) to operate as the balance drum disposed under the first inlet duct 38, 92.

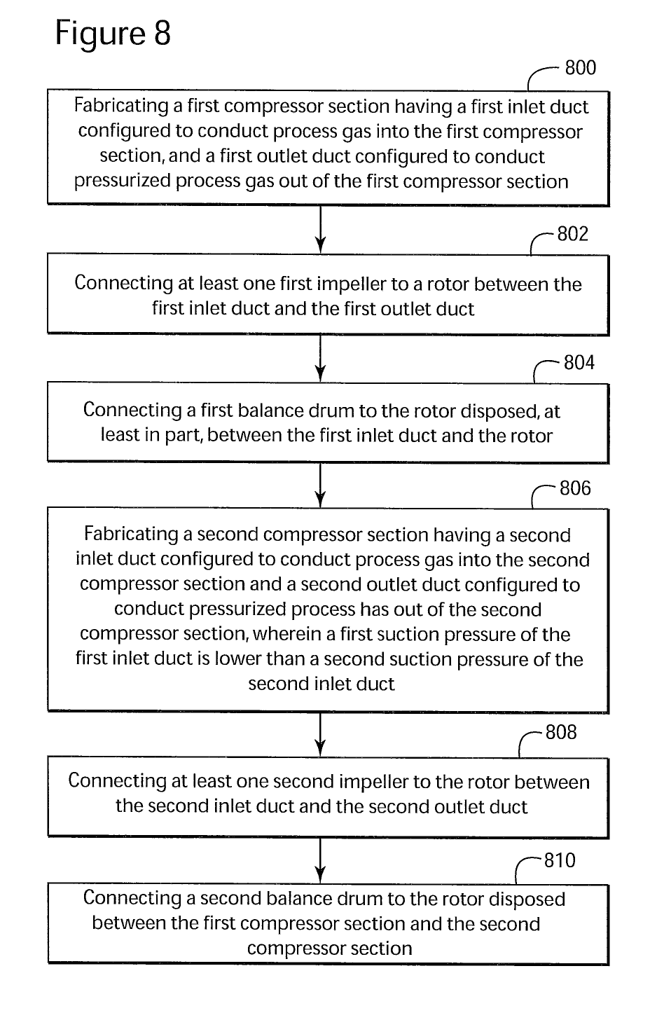

Moreover the exemplary embodiments further include a method of manufacturing such back-to-back compressors, e.g., as shown in the flowchart of FIG. 8. Therein, a method of manufacturing a back-to-back compressor includes the steps of fabricating (step 800) a first compressor section having a first inlet duct configured to conduct process gas into the first compressor section, a first outlet duct configured to conduct pressurized process gas out of the first compressor section, connecting (step 802) at least one first impeller to a rotor between the first inlet duct and the first outlet duct, connecting (step 804) a first balance drum to the rotor disposed, at least in part, between the first inlet duct and said rotor. A second compressor section is fabricated (step 806) to include a second inlet duct configured to conduct process gas into said second compressor section and a second outlet duct configured to conduct pressurized process gas out of the second compressor section, wherein a first suction pressure of the first inlet duct is higher than a second suction pressure of the second inlet duct. At least one second impeller is connected (step 808) to the rotor between the second inlet duct and the second outlet duct. A second balance drum is connected (step 810) to the rotor and disposed between the first compressor section and the second compressor section. It will be appreciated by those skilled in the art that the steps illustrated in FIG. 8 need not be performed in the order in which they are listed or have been described.

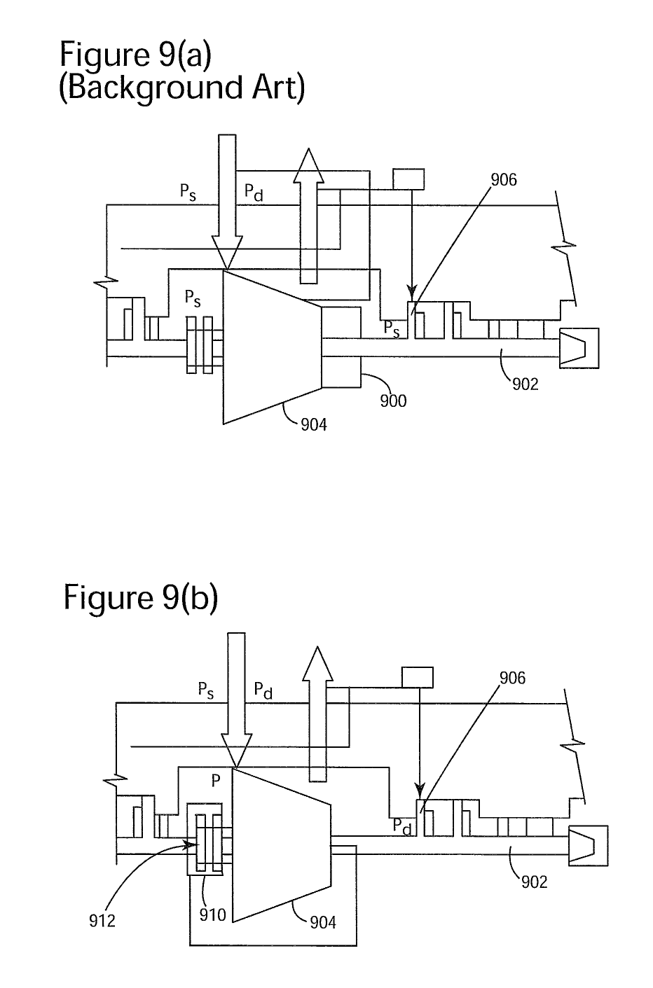

The disclosed exemplary embodiments provide a system and a method for balancing a rotor associated with, e.g., a back-to-back compressor. It should be understood that this description is not intended to limit the invention. On the contrary, the exemplary embodiments are intended to cover alternatives, modifications and equivalents, which are included in the spirit and scope of the invention as defined by the appended claims. For example, inline configurations can also be used in conjunction with the reversed balance drum orientation described herein. FIG. 9(a) depicts a stage of a conventional, inline compressor wherein the balance drum 900 is disposed on rotor 902 on the discharge side of the impeller 904. Here, the dry gas seal 906 is provided with the suction pressure Ps. By way of contrast, according to an exemplary embodiment of an inline compressor depicted in FIG. 9(b), the balance drum 910 is moved to the inlet or suction side of the impeller 904, e.g., as part of a bolted flange arrangement 912, rather than the discharge side of the impeller. In the exemplary embodiment of FIG. 9(b), the dry gas seal is provided with the discharge pressure Pd. In particular, such an arrangement according to the exemplary embodiment of FIG. 9(b) may be desirable in low pressure/low temperature compressors. Although FIG. 9(b) illustrates only one compressor, it will be appreciated that from 1 to n stages may be provided wherein n is any integer.

Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A multi-stage compressor comprising:
a housing;
a rotor;
a first compressor section including:
a first inlet duct configured to conduct process gas into said first compressor section;
a first outlet duct configured to conduct pressurized process gas out of said first compressor section;
at least one first impeller connected to said rotor between said first inlet duct and said first outlet duct; and
a first balance drum connected to said rotor and disposed, at least in part, between said first inlet duct and said rotor; and
a second compressor section including:
a second inlet duct configured to conduct process gas into said second compressor section;
a second outlet duct configured to conduct pressurized process gas out of said second compressor section;
at least one second impeller connected to said rotor between said second inlet duct and said second outlet duct; and
a second balance drum connected to said rotor and disposed between said first compressor section and said second compressor section;
wherein a first volume of said first inlet duct is greater than a second volume of said second inlet duct.

2. The compressor of claim 1, wherein said rotor is a unitary rotor.

3. The compressor of claim 1, wherein said rotor is a stacked rotor comprised of a plurality of segments.

4. The compressor of claim 3, wherein said plurality of segments includes flanges bolted together.

5. The compressor of claim 4, wherein one of said flanges is configured to operate as said first balance drum.

6. The compressor of claim 1, further comprising:
at least one bearing at each end of said rotor for rotatably supporting said rotor; and
at least one dry gas seal disposed between said at least one bearing and a respective one of said at least one first impeller and said at least one second impeller.

7. The compressor of claim 5, wherein each of said at least one dry gas seals operates at said second suction pressure.

8. The compressor of claim 1, wherein said first inlet duct is adapted to permit said first balance drum to be disposed between said first inlet duct and said rotor.

9. A method of manufacturing a compressor comprising:
fabricating a first compressor section including:
a first inlet duct configured to conduct process gas into said first compressor section;
a first outlet duct configured to conduct pressurized process gas out of said first compressor section;
connecting at least one first impeller to a rotor between said first inlet duct and said first outlet duct; and
connecting a first balance drum to said rotor disposed, at least in part, between said first inlet duct and said rotor; and
fabricating a second compressor section including:
a second inlet duct configured to conduct process gas into said second compressor section; and
a second outlet duct configured to conduct pressurized process gas out of said second compressor section wherein a first volume of said first inlet duct is greater than a second volume of said second inlet duct;
connecting at least one second impeller connected to said rotor between said second inlet duct and said second outlet duct; and
connecting a second balance drum to said rotor between said first compressor section and said second compressor section.

10. A rotary machine comprising:
a housing configured to contain elements of said rotary machine;
a rotor configured to rotate at least some of said elements of said rotary machine;
an inlet duct configured to conduct process gas into said rotary machine;
an outlet duct configured to conduct pressurized process gas out of said first section;
at least one impeller connected to said rotor between said inlet duct and said outlet duct and configured to pressurize said process gas; and
a balance drum connected to said rotor, disposed, at least in part, between said inlet duct and said rotor, and configured to balance axial thrust.
